(19) United States
(12) Patent Application Publication
(10) Pub. No.: US 2026/0017671 A1
(43) Pub. Date: Jan. 15, 2026

(54) METHOD AND APPARATUS FOR DISPLAYING CARBON INTENSITIES, AND DEVICE, STORAGE MEDIUM, AND PROGRAM PRODUCT THEREOF

(71) Applicants: ENVISION DIGITAL INTERNATIONAL PTE. LTD., Singapore (SG); SHANGHAI ENVISION DIGITAL CO., LTD., Shanghai, Shanghai (CN)

(72) Inventors: Guangyi LIU, Redwood City, CA (US); Haiming FU, Shanghai (CN); Yachen TANG, Redwood City, CA (US); Zhihong LI, Shanghai (CN); Jiayi ZHANG, Shanghai (CN)

(73) Assignees: ENVISION DIGITAL INTERNATIONAL PTE. LTD., Singapore (SG); SHANGHAI ENVISION DIGITAL CO., LTD., Shanghai (CN)

(21) Appl. No.: 18/993,964

(22) PCT Filed: Mar. 24, 2023
(86) PCT No.: PCT/SG2023/050196

§ 371 Date: Jan. 13, 2025

(30) Foreign Application Priority Data
Jul. 12, 2022 (CN) 202210819574.6

(51) Int. Cl. G06Q 30/018

(52) U.S. Cl. CPC G06Q 30/018

(57) ABSTRACT

Disclosed are a method for displaying carbon intensities and apparatus. The method includes: acquiring power flow data of power nodes in a power system, wherein the power nodes include a power station node, a transmission station node, and a load station node; processing the power flow data based on a carbon balance relationship to acquire node carbon intensity of each of the power nodes, wherein the node carbon intensity is a carbon emission on a power generation side when the power node generates, transmits or consumes a unit amount of power, and the carbon balance relationship indicates a balance between a total carbon emission corresponding to a power consumption of the power system and a total carbon emission from power generation by the power system; and displaying the node carbon intensity of each of the power nodes on a topological graph of the power nodes, wherein the topological graph of the power nodes indicates a connection relationship between the power nodes.

### TECHNICAL FIELD

Embodiments of the present disclosure relate to the technical field of energy, and in particular, relate to a method and apparatus for displaying carbon intensities, and a device, a storage medium, and a program product thereof.

### BACKGROUND

For the dual carbon (carbon peaking and carbon neutrality) goals, it is necessary to monitor carbon emissions of energy industries. The carbon emissions in the power industry account for a relatively high proportion, and therefore, it is important to monitor the carbon emissions in the power industry.

In the related art, in the monitoring of the carbon emissions in the power industry, the carbon emission in a region is calculated based on net power generation amount, fuel type, and fuel consumption of a power plant in the region, and thus a carbon intensity of the region is determined. In this way, only the carbon intensity of the region is acquired, and the carbon intensity of each node (such as a power consumption node) in the region fails to be specifically monitored because a particle size of carbon intensity analysis is low, such that carbon emissions fail to be tracked and traced.

### SUMMARY

Embodiments of the present disclosure provide a method and apparatus for displaying carbon intensities, and a computer device, a storage medium, and a program product thereof.

According to an aspect, the embodiments of the present disclosure provide a method for displaying carbon intensities. The method includes:
acquiring power flow data of power nodes in a power system, wherein the power nodes include a power station node, a transmission station node, and a load station node;
acquiring a node carbon intensity of each of the power nodes by processing the power flow data based on a carbon balance relationship, wherein the node carbon intensity indicates a carbon emission on a power generation side when the power node generates, transmits or consumes a unit amount of power, and the carbon balance relationship indicates a balance between a total carbon emission corresponding to a power consumption of the power system and a total carbon emission from power generation by the power system; and
displaying the node carbon intensity of each of the power nodes on a topological graph of the power nodes, wherein the topological graph of the power nodes indicates a connection relationship between the power nodes, and different node carbon intensities are displayed in different display patterns.

According to another aspect, the embodiments of the present disclosure further provide an apparatus for displaying carbon intensities. The apparatus includes:
a data acquiring module, configured to acquire power flow data of power nodes in a power system, wherein the power nodes include a power station node, a transmission station node, and a load station node;
a carbon intensity determining module, configured to acquire a node carbon intensity of each of the power nodes by processing the power flow data based on a carbon balance relationship, wherein the node carbon intensity indicates a carbon emission on a power generation side when the power node generates, transmits or consumes a unit amount of power, and the carbon balance relationship indicates a balance between a total carbon emission corresponding to a power consumption of the power system and a total carbon emission from power generation by the power system; and
a carbon intensity displaying module, configured to display the node carbon intensity of each of the power nodes on a topological graph of the power nodes, wherein the topological graph of the power nodes indicates a connection relationship between the power nodes, and different node carbon intensities are displayed in different display patterns.

According to another aspect, the embodiments of the present disclosure further provide a computer device. The computer device includes a processor and a memory storing at least one instruction, at least one program, a code set, or an instruction set. The at least one instruction, the at least one program, the code set, or the instruction set, when loaded and executed by the processor, causes the computer device to perform the method for displaying carbon intensities according to the above aspect.

According to another aspect, the embodiments of the present disclosure further provide a computer-readable storage medium storing at least one instruction, at least one program segment, a code set, or an instruction set, and the at least one instruction therein. The at least one program segment, the code set, or the instruction set, when loaded and executed by a processor of a computer device, causes the computer device to perform the method for displaying carbon intensities according to the above aspect.

According to another aspect, the embodiments of the present disclosure further provide a computer program product or a computer program, wherein the computer program product or the computer program includes at least one computer instruction stored in a computer-readable storage medium. The at least one computer program, when loaded and run by a processor of a computer device, causes the computer device to perform the method for displaying carbon intensities according to the above aspect.

The technical solutions according to the embodiments of the present disclosure achieve the following beneficial effects:

In the embodiments of the present disclosure, the node carbon intensity of each of the power nodes in the power system is calculated based on the power flow data of the power nodes in the power system and the total carbon emission from power generation by the power system, such that the node carbon intensities corresponding to the power station node, the transmission station node, and the load station node in the power system is acquired and displayed on the topological graph of the power nodes. In this way, the corresponding carbon intensity of each node in the power system is accurately monitored, a particle size of carbon intensity analysis is increased. In addition, the carbon intensity of each of the power nodes is displayed on the topological graph of the power nodes, such that distribution of carbon flow trajectories is visually displayed, and hence carbon emissions are tracked and traced.

### BRIEF DESCRIPTION OF THE DRAWINGS

For clearer description of the technical solutions in the embodiments of the present disclosure more clearly, the following briefly describes the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a schematic diagram of an implementation environment according to an exemplary embodiment of the present disclosure;

FIG. 2 is a flowchart of a method for displaying carbon intensities according to an exemplary embodiment of the present disclosure;

FIG. 3 is a flowchart of a method for displaying carbon intensities according to another exemplary embodiment of the present disclosure;

FIG. 4 is a schematic diagram of a carbon calculation method according to an exemplary embodiment of the present disclosure;

FIG. 5 is a flowchart of a method for displaying carbon intensities according to another exemplary embodiment of the present disclosure;

FIG. 6 is a schematic diagram of a carbon intensity display screen according to an exemplary embodiment of the present disclosure;

FIG. 7 is a flowchart of a method for displaying carbon intensities according to another exemplary embodiment of the present disclosure;

FIG. 8 is a schematic diagram of implementing a data access management process according to an exemplary embodiment of the present disclosure;

FIG. 9 is a flowchart of a calculation process of node carbon intensities according to an exemplary embodiment of the present disclosure;

FIG. 10 is a structural block diagram of an apparatus for displaying carbon intensities according to an exemplary embodiment of the present disclosure; and

FIG. 11 is a schematic structural diagram of a computer device according to an exemplary embodiment of the present disclosure.

### DETAILED DESCRIPTION OF THE EMBODIMENTS

for clearer descriptions of the objectives, technical solutions, and advantages of the present disclosure, the embodiments of the present disclosure are further described in detail with reference to the accompanying drawings.

At present, for dual carbon goals, carbon emissions are being monitored in various industries. In the related art, a total carbon emission of a whole power system is determined only based on total power generation amount, fuel type, and fuel consumption of the power system. In other words, only the total carbon emission of the power system is obtained, but actual carbon flow distribution in the power system fails to be acquired. For example, carbon emissions caused by power transmission and power consumption fail to be determined.

In the embodiments of the present disclosure, a carbon intensity display pattern is provided. In this display pattern, a node carbon intensity of each of power nodes in a power system is determined based on power flow data and a carbon balance relationship in the power system, such that the carbon intensity of each node is monitored. In addition, the carbon intensity is displayed, such that carbon flow distribution of the power system is visually displayed, and hence carbon emissions are tracked and traced.

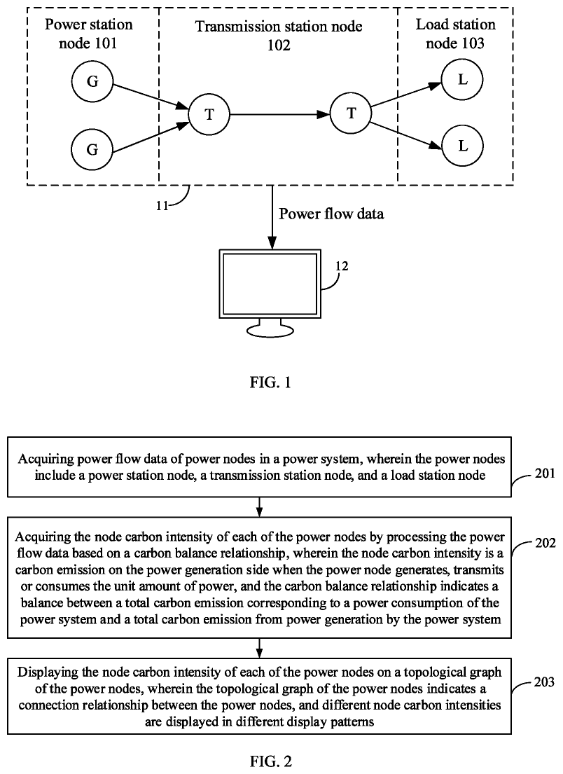

FIG. 1 is a schematic diagram of an implementation environment according to an exemplary embodiment of the present disclosure. The implementation environment includes a power system 11 and a computer device 12, wherein the power system 11 includes power nodes, and the power nodes include a power station node 101, a transmission station node 102, and a load station node 103. The computer device 12 is an electronic device for determining and displaying node carbon intensities. The electronic device may be a mobile terminal such as a smart phone, a tablet computer, or a laptop, may be a terminal such as a desktop computer or a projection computer, or may be a cloud server for computing, which is not limited in the embodiments of the present disclosure.

Data communication is performed between the power system 11 and the computer device 12 over a communications network. In some embodiments, the communications network may be a wired network or a wireless network, and the communications network may be at least one of a local area network, a metropolitan area network, and a wide area network.

In some embodiments, the computer device 12 acquires power flow data of the power nodes in the power system 11, and acquires a node carbon intensity of each of the power nodes through analysis based on the power flow data. Then, the node carbon intensity of each of the power nodes is displayed, the carbon intensity of each of the power nodes in the power system 11 is accurately monitored and a carbon flow trajectory is analyzed, and hence carbon emissions are tracked and traced.

FIG. 2 is a flowchart of a method for displaying carbon intensities according to an exemplary embodiment of the present disclosure. This embodiment is described with an example in which the method is applicable to a computer device. The method includes the following steps.

In step 201, power flow data of power nodes in a power system is acquired, wherein the power nodes include a power station node, a transmission station node, and a load station node.

In some embodiments, power transmitted between the power nodes in the power system and power generated and consumed in the power system are calculated based on the power flow data. The power node is a basic unit of power production, transmission and consumption, as well as a basic unit of collecting and distributing an energy flow and a carbon flow in the power system. In the power system, the power station node generates power and transmits the power to the transmission station node. The transmission station node transmits the power to the load station node, and the load station node consumes the power.

When the node carbon intensity of a power node represents a unit amount of power consumed by the node, a carbon emission generated from a power generation side is denoted as CI with a dimension being kgCO₂/(kW·h). The node carbon intensity of each of the power nodes is related to an amount of power generated, transmitted or consumed by the node. For example, when the power node is the power station node, the node carbon intensity is related to an amount of power generated by the node; when the power node is the transmission station node, the node carbon intensity is related to an amount of power transmitted by the node; or when the power node is the load station node, the node carbon intensity is related to an amount of power consumed by the node. In some embodiments, the computer device acquires the power flow data of the power nodes in the power system and determines the node carbon intensity corresponding to each of the power nodes.

In step 202, the node carbon intensity of each of the power nodes is acquired by processing the power flow data based on a carbon balance relationship, wherein the node carbon intensity is a carbon emission on the power generation side when the power node generates, transmits or consumes the unit amount of power, and the carbon balance relationship indicates a balance between a total carbon emission corresponding to a power consumption of the power system and a total carbon emission from power generation by the power system.

The total carbon emission corresponding to the power consumption of the power system and the total carbon emission from power generation by the power system are balanced. The power consumption of the power system includes a transmission power consumption and a load power consumption. The node carbon intensity is the carbon emission on the power generation side when the power node generates, transmits or consumes the unit amount of power. Optionally, a node carbon intensity of the power station node is a corresponding power generation carbon emission when the node generates the unit amount of power; a node carbon intensity of the transmission station node is a carbon flow generated when the unit amount of power transmitted by the node is generated; and a node carbon intensity of the load station node is a power consumption carbon emission generated when the unit amount of power consumed by the node is generated.

Therefore, in some embodiments, based on the power flow data, the computer device calculates the power consumption of the power system and the total carbon emission from power generation by the system, and hence determines the node carbon intensity of each of the power nodes in the power system.

In step 203, the node carbon intensity of each of the power nodes is displayed on a topological graph of the power nodes, wherein the topological graph of the power nodes indicates a connection relationship between the power nodes, and different node carbon intensities are displayed in different display patterns.

In some embodiments, the computer device acquires topology data of the power system, and hence acquires the topological graph of the power nodes. The topological graph of the power nodes includes the power nodes in the power system and a power flow direction between the nodes, and two power nodes with a power transmission relationship are connected.

Upon determining the node carbon intensity of each of the power nodes, the computer device may determine a display pattern for displaying the power nodes on the topological graph of the power nodes based on a magnitude of the node carbon intensity. Optionally, the display pattern may be a node color, node brightness, a node shape, or the like. For example, when the node carbon intensities of two power nodes are high and low respectively, the two power nodes are displayed in different node colors.

The node carbon intensity of each of the power nodes is displayed on the topological graph of the power nodes, such that the carbon emission intensity caused by each of the nodes in the power system is visually displayed, and carbon flow distribution of the whole system is acquired and carbon intensities of the power system are accurately monitored. In this way, a source of a carbon emission of the power system is analyzed, which is conducive to accurate practice of low-carbon measures.

In conclusion, in this embodiment, the node carbon intensity of each of the power nodes in the power system is calculated based on the power flow data of the power nodes in the power system and the total carbon emission from power generation by the power system, such that the node carbon intensities corresponding to the power station node, the transmission station node, and the load station node in the power system are acquired and displayed on the topological graph of the power nodes. In this way, the corresponding carbon intensity of each node in the power system is accurately monitored, and a particle size of carbon intensity analysis is increased. In addition, the carbon intensity of each of the power nodes is displayed on the topological graph of the power nodes, such that distribution of carbon flow trajectories is visually displayed, and hence carbon emissions are tracked and traced.

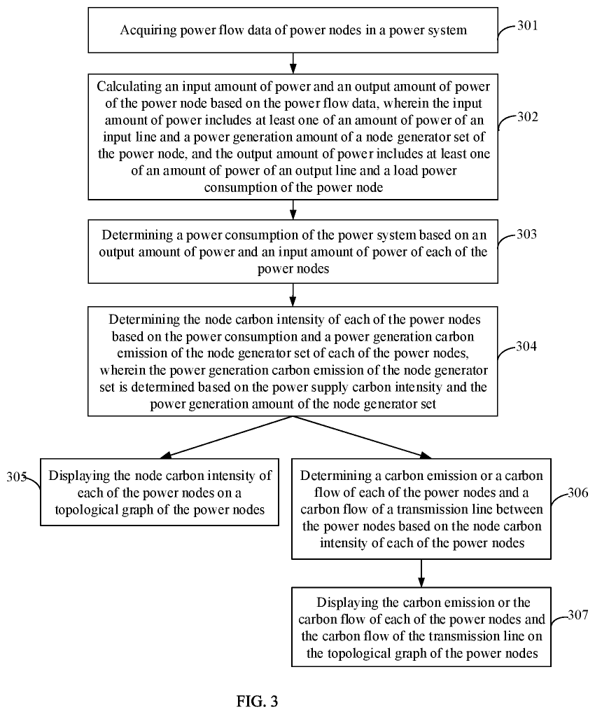

FIG. 3 is a flowchart of a method for displaying carbon intensities according to another exemplary embodiment of the present disclosure. This embodiment is described with an example in which the method for displaying carbon intensities is applied to a computer device. The method for displaying carbon intensities includes the following steps.

In step 301, power flow data of power nodes in a power system is acquired.

The power flow data of the power nodes in the power system is different. For example, amounts of power transmitted by a transmission station node in different time periods are different. Therefore, in some embodiments, the computer device acquires the power flow data of the power nodes in the power system every other target period, and hence determines the node carbon intensity of each of the power nodes in different time periods, thereby ensuring accuracy of the node carbon intensity.

In other words, power flow data of the power nodes in the power system within target time is acquired, and the node carbon intensity of each of the power nodes within the target time is determined based on the power flow data of the power system within the target time.

In step 302, an input amount of power and an output amount of power of the power node are calculated based on the power flow data, wherein the input amount of power includes at least one of an amount of power of an input line and a power generation amount of a node generator set of the power node, and the output amount of power includes at least one of an amount of power of an output line and a load power consumption of the power node.

The node carbon intensity of a power station node is determined based on a power generation amount of a generator set contained in the power station node and power supply carbon intensity of the generator set, wherein the power supply carbon intensity is a carbon emission of the generator set when the generator set generates a unit amount of power, which is denoted as ek. Different generator sets correspond to different carbon intensity. Optionally, a coal-fired set, a gas-fired set, a nuclear power set, a photovoltaic set, a wind turbine set, and a hydropower set correspond to different power supply carbon intensities.

In some embodiments, the node carbon intensity of a power station node containing k generator sets is calculated according to the following formula:

$${F}_{g k , t} = {\sum }_{k ∈ {G}_{k}} {G}_{k , t} \cdot {e}_{k}$$

$${CI}_{k , t} = {\sum }_{k ∈ {G}_{k}} {G}_{k , t} \cdot {e}_{k} / {\sum }_{k ∈ {G}_{k}} {G}_{k , t}$$

wherein F_{gk,t} represents a total carbon emission of the power station node within a target time t; G_{k,t} represents a total power generation amount of generator set k within the target time t; and CI_{k,t} represents the node carbon intensity of the power station node within the target time t.

A total carbon input of the transmission station node is equal to a total carbon amount of input lines connected to the transmission station node, and the node carbon intensity of the transmission station node is equal to the total carbon input of the transmission station node divided by a total input amount of power of the transmission station node, and is also equal to the total carbon input of the transmission station node divided by a total output amount of power of the transmission station node when a loss of the transmission station node itself is not considered. The total input amount of power is determined based on input active power of the transmission station node within the target time, and the total output amount of power is determined based on output active power within the target time. Corresponding calculation formulas are as follows:

$${F}_{k , t} = {\sum }_{i ∈ {B}_{Ik}} ( - {P}_{( k , i ) , t} ) \cdot {CI}_{i , t}$$

$$C {I}_{k , t} = {\sum }_{i ∈ {B}_{Ik}} ( - {P}_{( k , i ) , t} ) \cdot {CI}_{i , t} / {\sum }_{i ∈ {B}_{Ik}} {P}_{( k , i ) , t} = {\sum }_{i ∈ {B}_{ik}} ( - {P}_{( k , i ) , t} ) \cdot {CI}_{i , t} / {\sum }_{j ∈ {B}_{O k}} {P}_{( k , j ) , t}$$

wherein B_{Ik} and B_{Ok} represent an input line set and an output line set of transmission station node k respectively; (−P_{(k,i),t})·CI_{i,t} represents a carbon amount acquired by multiplying a total amount of power of all input lines of transmission station node k by carbon intensity of transmission station node k; Σ_{i∈B}_{_{Ik}}P_{(k,i),t} represents a total input amount of power; and Σ_{j∈B}_{_{Ok}}P_{(k,j),t} represents a total output amount of power.

A total carbon input of a load station node is equal to a total carbon amount of input lines connected to the load station node, and the node carbon intensity of the load station node is equal to the total carbon input of the load station node divided by a total input amount of power of the load station node, or is equal to a sum of a total output amount of power and total load. Corresponding calculation formulas are as follows:

$${F}_{k , t} = {\sum }_{i ∈ {B}_{Ik}} ( - {P}_{( k , i ) , t} ) \cdot {CI}_{i , t}$$

$$C {I}_{k , t} = {\sum }_{i ∈ {B}_{Ik}} ( - {P}_{( k , i ) , t} ) \cdot {CI}_{i , t} / {\sum }_{i ∈ {B}_{Ik}} {P}_{( k , i ) , t} = {\sum }_{i ∈ {B}_{ik}} ( - {P}_{( k , i ) , t} ) \cdot {CI}_{i , t} / ( {\sum }_{j ∈ {B}_{O k}} {P}_{( k , j ) , t} + {L}_{k , t} )$$

wherein L_{k,t} represents total load of load station node k.

In addition, the load station node may also have a distributed power supply for power generation. In this case, the total load of the load station node may be a difference between a load amount of the load station node and a power generation amount of the distributed power supply in the load station node, namely,

$${L}_{k , t} = {L}_{k , t}^{′} - {G}_{k , t}$$

wherein

$${L}_{k , t}^{′}$$

represents the load amount of the load station node, and G_{k,t} represents the power generation amount of the distributed power supply.

In some embodiments, a carbon amount corresponding to the power generation amount of the distributed power supply may be included in the total carbon input, in other words, the total carbon input is as follows:

$${F}_{k , t} = {\sum }_{i ∈ {B}_{Ik}} ( - {P}_{( k , i ) , t} ) \cdot {CI}_{i , t} + {G}_{k , t} \cdot {e}_{k}$$

In the above description, carbon intensity of different power nodes is calculated in different manners. In some embodiments, a general carbon balance equation is provided for different power nodes, which is applicable to any node.

In some embodiments, for any type of power station node, transmission station node, or load station node, their output amount of power and input amount of power are balanced, as shown in the following formula:

$${\sum }_{i ∈ {B}_{Ik}} ( - {P}_{( k , i ) , t} ) + {G}_{k , t} = {\sum }_{j ∈ {B}_{Ok}} {P}_{( k , j ) , t} + {L}_{k , t}$$

wherein Σ_{i∈B}_{_{Ik}}(−P_{(k,i),t}) represents the amount of power of the input line; G_{k,t} represents the power generation amount of the node generator set contained in the node; Σ_{j∈B}_{_{Ok}}P_{(k,j),t} represents the amount of power of the output line; and L_{k,t} represents the load power consumption.

Correspondingly, a carbon output and a carbon input of the node are balanced, and the carbon balance equation is as follows:

$${\sum }_{i ∈ {B}_{Ik}} ( - {P}_{( k , i ) , t} ) \cdot {CI}_{i , t} + {G}_{k , t} \cdot {e}_{k} = ( {\sum }_{j ∈ {B}_{O k}} {P}_{( k , j ) , t} + {L}_{k , t} ) \cdot {CI}_{k , t}$$

wherein CI_{i,t} and CI_{k,t} are the same, indicating the node carbon intensities.

In some embodiments, for each of the power nodes, the input amount of power of the input line, the power generation amount of the node generator set, the amount of power of the output line, and the load power consumption are calculated based on the power flow data, and the computer device further acquires the power supply carbon intensity of the node generator set, and hence calculates the node carbon intensity of each of the power nodes based on a carbon balance equation of each of the power nodes.

In some embodiments, the power generation amount of the node generator set and the amount of power of the output line are calculated based on power flow data of the power station node. The amount of power of the output line is calculated based on active power data of an output line of the power station node.

In some embodiments, the amount of power of the input line and the amount of power of the output line are calculated based on power flow data of the transmission station node. The amount of power of the input line is determined based on active power data of the input line of the transmission station node, and the amount of power of the outline line is calculated based on active power data of an output line of the transmission station node.

In some embodiments, the amount of power of the input line and the load power consumption are calculated based on power flow data of the load station node. The amount of power of the input line is calculated based on active power data of the input line of the load station node.

In step 303, a power consumption of the power system is determined based on an output amount of power and an input amount of power of each of the power nodes.

According to the above carbon balance equation, a carbon emission corresponding to the power consumption of the power system is balanced with a carbon emission corresponding to a power generation amount of a generator set in the system.

In some embodiments, a power matrix is constructed based on a balance principle of the output amount of power and the input amount of power of each of the power nodes, wherein a matrix dimension of the power matrix is the same as a quantity of the power nodes, and the power matrix indicates input and output amounts of power or power consumptions of the power nodes. In other words, the power matrix indicates the input and output amounts of power of the transmission station node or the power consumption of the load station node, and hence indicates the power consumption of the power system. Based on the balance principle between the output amount of power and the input amount of power of each of the power nodes, it is learned that a difference between the output amount of power of each of the power nodes and the amount of power of the input line of each of the power nodes is balanced with the power generation amount of the node generator set. The power matrix is constituted by a difference between an output amount of power matrix of each of the power nodes and an amount of power matrix of the input line of each of the power nodes.

Schematically, for a power system with s power nodes, the power matrix is expressed as follows:

$${H}_{t} = diag ( {\sum }_{j ∈ {B}_{O k}} {P}_{( k j ) , t} + {L}_{k , t} ) - {P}_{t}$$

wherein Pₜ represents an S*S power input matrix constituted by an amount of power −P_{(k,i),t} of each input line; and Hₜ represents an S*S power matrix.

In step 304, the node carbon intensity of each of the power nodes is determined based on the power consumption and a power generation carbon emission of the node generator set of each of the power nodes, wherein the power generation carbon emission of the node generator set is determined based on the power supply carbon intensity and the power generation amount of the node generator set.

Upon acquiring the power consumption of the power system, the computer device determines the node carbon intensity of each of the power nodes based on the power consumption and the power generation carbon emission of the node generator set. This step may include steps 304a and 304b, which is not described herein any further.

In step 304a, a power carbon emission vector is constructed based on the power generation carbon emission of the node generator set of each of the power nodes.

The power carbon emission vector is expressed as follows:

$${F}_{t} = {[ {G}_{1 , t} \cdot {e}_{1} , … {G}_{s , t} \cdot {e}_{s} … , {G}_{S , t} \cdot {e}_{S} ]}^{T}$$

In step 304b, a carbon intensity matrix is determined based on the power matrix and the power carbon emission vector, wherein the carbon intensity matrix indicates the node carbon intensity of each of the power nodes.

A node carbon matrix equation of the power system is acquired based on the carbon balance equation:

$${H}_{t} \cdot {CI}_{t} = {F}_{t}$$

The carbon intensity matrix is calculated based on the power matrix and the power carbon emission vector. The carbon intensity matrix is an s-dimension matrix and includes the node carbon intensity of each of the power nodes.

In step 305, the node carbon intensity of each of the power nodes is displayed on a topological graph of the power nodes.

The node carbon intensity of each of the power nodes, upon being acquired, is displayed on the topological graph of the power nodes. For details about the display patterns, reference may be made to the following embodiment, which are thus not described herein any further.

In step 306, a carbon emission or a carbon flow of each of the power nodes and a carbon flow of a transmission line between the power nodes are determined based on the node carbon intensity of each of the power nodes.

In some embodiments, when the node carbon intensity of each of the power nodes is acquired, the carbon emission or the carbon flow of each of the power nodes and the carbon flow of the transmission line between the power nodes are further determined based on the node carbon intensity of each of the power nodes, and hence carbon emissions are tracked and traced. In addition, the carbon emission of each of the power nodes is further used in subsequent carbon emission management. For example, when a carbon emission of a node exceeds a specified emission, an early warning is given in time.

Carbon emissions or carbon flows of different nodes are determined in different manners. A product of a total power generation amount of a node generator set of the power station node and the node carbon intensity of the power station node is determined as a power generation carbon emission of the power station node. A product of an amount of power of the input line of the transmission station node and the node carbon intensity of the transmission station node is determined as a carbon flow of the transmission station node. A product of a load power consumption of the load station node and the node carbon intensity of the load station node is determined as a power consumption carbon emission of the load station node.

A network loss is present in a power transmission process of the transmission line, and corresponding line carbon intensity of the transmission line is the same as a node carbon intensity of an output-end node of the transmission line. In other words, a product of a transmitted amount of power of the transmission line and the node carbon intensity of the output-end node of the transmission line is determined as a carbon flow of the transmission station node.

In step 307, the carbon emission or the carbon flow of each of the power nodes and the carbon flow of the transmission line are displayed on the topological graph of the power nodes.

The carbon emission of each of the power nodes and the carbon flow of the transmission line are displayed on the topological graph of the power nodes after being determined. Different carbon emissions or carbon flows of the power nodes are displayed in different display patterns. In addition, the node carbon intensity and the carbon emission of the power node are displayed in different display patterns. For example, the node carbon intensity of the power node is displayed in a node color, and the carbon emission is displayed in a node size. Alternatively, the node carbon intensity and the carbon emission of the power node may be displayed in other different display patterns, and this is not limited in this embodiment.

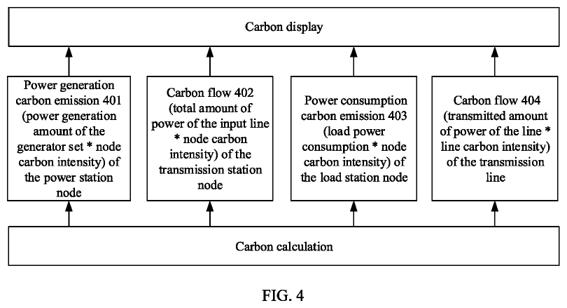

As shown in FIG. 4, when the node carbon intensity is determined, the power generation carbon emission 401 (power generation amount of the generator set*node carbon intensity) of the power station node, the carbon flow 402 (total amount of power of the input line*node carbon intensity) of the transmission station node, the power consumption carbon emission 403 (load power consumption*node carbon intensity) of the load station node, and the carbon flow 404 (transmitted amount of power of the line*line carbon intensity) of the transmission line is calculated and displayed.

In this exemplary embodiment, the node carbon intensity of each of the power node in the power system is determined based on the general carbon balance equation, which is simple and efficient, and is suitable for large-scale power systems. In addition, because only the input amount of power and the output amount of power of the power node are considered, the method is applicable to ring-type power systems.

Moreover, in this exemplary embodiment, in addition to the node carbon intensity of the power node, the carbon emission of each node and the carbon flow in the line are also displayed on the topological graph of the power nodes. When a node has a large carbon emission in the power system, an early warning is given in time, which is conducive to practice of low-carbon programs.

In the above embodiments, the calculation method of the node carbon intensity and the carbon emission of each of the power nodes in the power system is described. The carbon intensity and the carbon emission, upon being determined, are displayed on the topological graph of the power nodes. An exemplary description of the display method is given below.

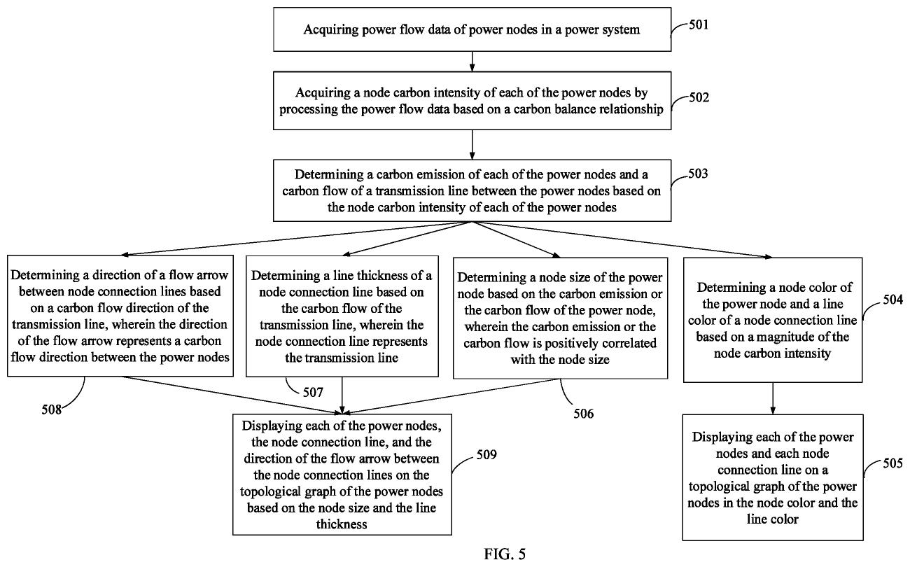

FIG. 5 is a flowchart of a method for displaying carbon intensities according to another exemplary embodiment of the present disclosure. This embodiment is described with an example in which the method for displaying carbon intensities is applicable to a computer device. The method includes the following steps.

In step 501, power flow data of power nodes in a power system is acquired.

In step 502, a node carbon intensity of each of the power nodes is acquired by processing the power flow data based on a carbon balance relationship.

In step 503, a carbon emission of each of the power nodes and a carbon flow of a transmission line between the power nodes are determined based on the node carbon intensity of each of the power nodes.

For implementations of steps 501 to 503, reference may be made to the above embodiment, which are not described herein any further.

In step 504, a node color of the power node and a line color of a node connection line are determined based on a magnitude of the node carbon intensity.

In some embodiments, the node connection line represents the transmission line between the power nodes, the line color indicates line carbon intensity, and the line carbon intensity is the same as node carbon intensity of an output-end node of the transmission line.

In some embodiments, the node carbon intensity is displayed in the node color. The computer device determines the node color of the power node based on the magnitude of the node carbon intensity. In this process, an intensity grade of the node carbon intensity is determined based on the node carbon intensity. A correspondence relationship between different intensity grades and node colors is stored in the computer device in advance, and a corresponding node color is determined based on an intensity grade.

In some embodiments, a correspondence relationship between a node carbon intensity and an intensity grade may be set by development personnel by default or may be user-defined. For example, a node carbon intensity greater than a first intensity threshold belongs to a high intensity grade; a node carbon intensity less than the first intensity threshold and greater than a second intensity threshold belongs to a medium intensity grade; and a node carbon intensity less than the second intensity threshold belongs to a low intensity grade. The computer device determines a corresponding intensity grade based on the correspondence.

In some embodiments, a node color corresponding to the high intensity grade may be black, a node color corresponding to the medium intensity grade may be gray, and a node color corresponding to the low intensity grade may be white. Alternatively, a node color corresponding to the high intensity grade may be red, a node color corresponding to the medium intensity grade may be yellow, and a node color corresponding to the low intensity grade may be green. This is not limited in this embodiment.

In addition, the line carbon intensity of the transmission line is further displayed. The line color is the same as a node color of the output-end node.

In step 505, each of the power nodes and each node connection line are displayed on a topological graph of the power nodes in the node color and the line color.

A node color of each of the power nodes and a line color corresponding to each node connection line, upon being determined, are displayed on the topological graph of the power nodes.

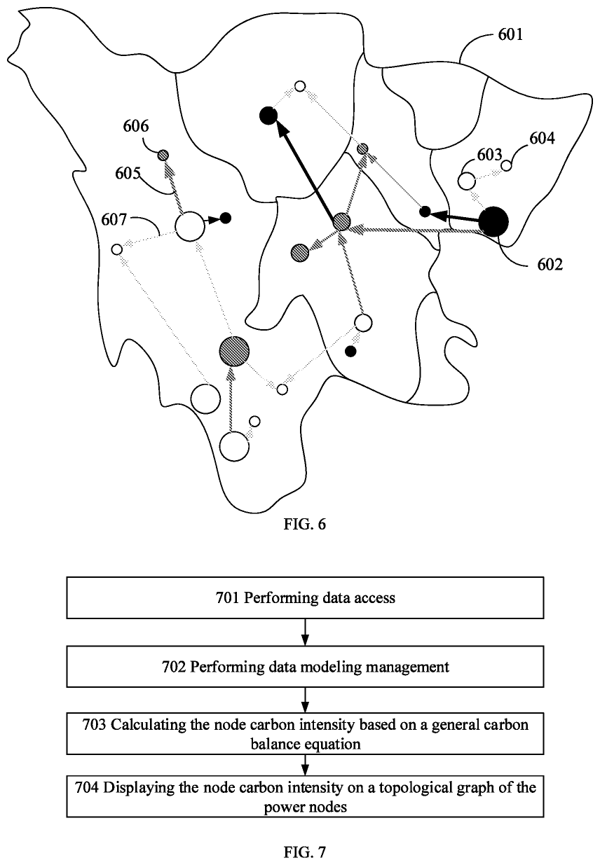

Schematically, referring to FIG. 6, the node carbon intensity of each of the power nodes is displayed on a topological graph 601 of the power nodes. The node carbon intensity of a first power node 602 belongs to the high intensity grade, and a corresponding node color is black; the node carbon intensity of a second power node 603 belongs to the medium intensity grade, and a corresponding node color is gray; and the node carbon intensity of a third power node 604 belongs to the low intensity grade, and a corresponding node color is white. A transmission line 605 transmits power to a fourth power node 606, and a line color of a corresponding node connection line of the transmission line 605 is gray.

In step 506, a node size of the power node is determined based on the carbon emission or the carbon flow of the power node, wherein the carbon emission or the carbon flow is positively correlated with the node size.

In some embodiments, a carbon emission of a power station node or a load station node and a carbon flow of a transmission station node are displayed in terms of the node size. A higher carbon emission or carbon flow of the power node leads to a larger node size. Optionally, a correspondence relationship between a node size and a carbon emission or a carbon flow is stored in the computer device, and may be preset by the development personnel or may be user-defined.

Schematically, when it is determined that the carbon emission or the carbon flow is high, a circular node whose node size is a first radius is determined; when it is determined that the carbon emission or the carbon flow is medium, a circular node whose node size is a second radius is determined; when it is determined that the carbon emission or the carbon flow is low, a circular node whose node size is a third radius is determined. The first radius is greater than the second radius, and the second radius is greater than the third radius.

In step 507, a line thickness of a node connection line is determined based on the carbon flow of the transmission line, wherein the node connection line represents the transmission line.

Correspondingly, the computer device determines the line thickness of the node connection line based on the carbon flow of the transmission line. The carbon flow is positively correlated with the line thickness. A larger carbon flow leads to a thicker line. Schematically, when it is determined that the carbon flow is high, the line thickness is determined as a first magnitude; when it is determined that the carbon flow is medium, the line thickness is determined as a second magnitude; when it is determined that the carbon flow is low, the line thickness is determined as a third magnitude.

In step 508, a direction of a flow arrow between node connection lines is determined based on a carbon flow direction of the transmission line, wherein the direction of the flow arrow represents a carbon flow direction between the power nodes.

In some embodiments, the computer device further determines the direction of the flow arrow between the node connection lines based on the carbon flow direction of the transmission line, and hence displays a carbon flow trajectory. The carbon flow direction of the transmission line is the same as a power transmission direction of the transmission line.

In step 509, each of the power nodes, the node connection line, and the direction of the flow arrow between the node connection lines are displayed on the topological graph of the power nodes based on the node size and the line thickness.

The node size of each of the power nodes, the line thickness of each node connection node, and the direction of the flow arrow between the node connection lines, upon being determined, are displayed on the topological graph of the power nodes.

As shown in FIG. 6, the first power node 602 has a high carbon emission and is a circular node whose node size is the first radius; the second power node 603 has a medium carbon mission and is a circular node whose node size is the second radius; and the fourth power node 606 has a low carbon emission and is a circular node whose node size is the third radius.

In addition, as shown in FIG. 6, the transmission line 605 has a higher carbon flow than a transmission line 607, and has a thicker node connection line than the transmission line 607.

The first power node 602 transmits power to the second power node 603. A carbon flow direction is from the first power node 602 to the second power node 603, and a direction of a flow arrow on a transmission line between the first power node 602 and the second power node 603 is from the first power node 602 to the second power node 603.

In some embodiments, as shown in FIG. 7, the method for displaying carbon intensities includes the following steps.

In step 701, data access is performed.

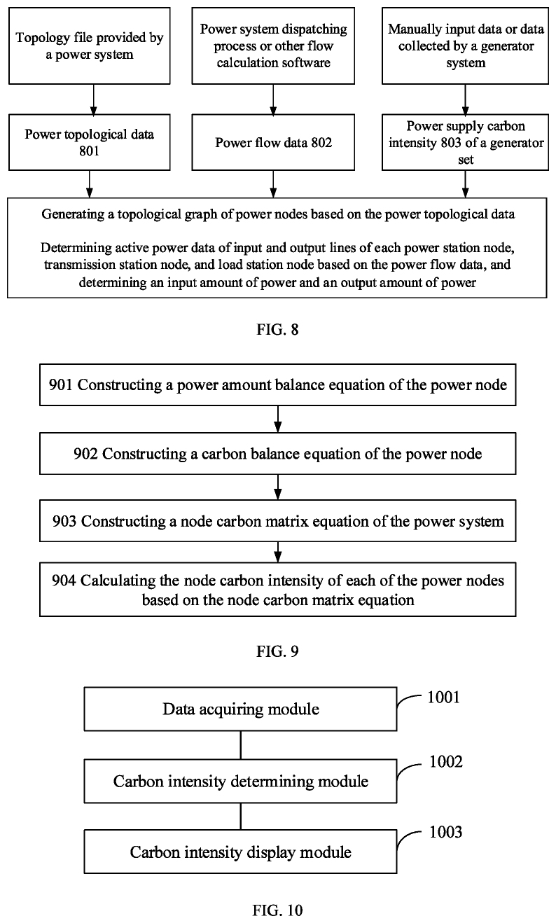

As shown in FIG. 8, during data access, the computer device acquires a topology file provided by the power system and determine power topological data 801, and acquires the power flow data 802 from a power system dispatching process or other flow calculation software. The computer device further determines a power supply carbon intensity 803 of the generator set based on manually input data or data collected by a generator system. Then, the computer device generates the topological graph of the power nodes based on the power topological data 801, and determines active power data of input and output lines of each power station node, transmission station node, and load station node based on the power flow data 802, and hence determines an input amount of power and an output amount of power.

In step 702, data modeling management is performed.

The data acquired by the computer device includes, but is not limited to, an amount, a power generation amount, and a power supply carbon intensity of each generator set, and includes an input line set and an output line set of the node, which may be stored separately, as shown in Table 1:

TABLE 1

| | Data name | Data type | Data description |
|---|---|---|---|
| 1 | Capacity of a coal-fired set of an access | Floating- | Capacity data of each coal-fired generator set, which is input |
| | node | point array | data |
| 2 | Power generation amount of the coal- | Floating- | Power generation data of each coal-fired generator set, which |
| | fired set of the access node | point array | is input data |
| 3 | Power supply carbon intensity of the | Floating- | Power supply carbon intensity of each coal-fired generator set, |
| | coal-fired set of the access node | point array | which is input data |
| 4 | Capacity of a gas-fired set of the access | Floating- | Capacity data of each gas-fired generator set, which is input |
| | node | point array | data |
| 5 | Power generation amount of the gas- | Floating- | Power generation data of each gas-fired generator set, which |
| | fired set of the access node | point array | is input data |
| 6 | Power supply carbon intensity of the | Floating- | Power supply carbon intensity of each gas-fired generator set, |
| | gas-fired set of the access node | point array | which is input data |
| 7 | Capacity of a nuclear power set of the | Floating- | Capacity data of each nuclear power generator set, which is |
| | access node | point array | input data |
| 8 | Power generation amount of the | Floating- | Power generation data of each nuclear power generator set, |
| | nuclear power set of the access node | point array | which is input data |
| 9 | Power supply carbon intensity of the | Floating- | Power supply carbon intensity of each nuclear power generator |
| | nuclear power set of the access node | point array | set, which is input data |
| 10 | Capacity of a photovoltaic set of the | Floating- | Capacity data of each photovoltaic generator set, which is |
| | access node | point array | input data |
| 11 | Power generation amount of the | Floating- | Power generation data of each photovoltaic generator set, |
| | photovoltaic set of the access node | point array | which is input data |
| 12 | Power supply carbon intensity of the | Floating- | Power supply carbon intensity of each photovoltaic generator |
| | photovoltaic set of the access node | point array | set, which is input data |
| 13 | Capacity of a wind turbine set of the | Floating- | Capacity data of each wind turbine generator set, which is |
| | access node | point array | input data |
| 14 | Power generation amount of the wind | Floating- | Power generation data of each wind turbine generator set, |
| | turbine set of the access node | point array | which is input data |
| 15 | Power supply carbon intensity of the | Floating- | Power supply carbon intensity of each wind turbine generator |
| | wind turbine set of the access node | point array | set, which is input data |
| 16 | Capacity of a hydropower set of the | Floating- | Capacity data of each hydropower generator set, which is input |
| | access node | point array | data |
| 17 | Power generation amount of the | Floating- | Power generation data of each hydropower generator set, |
| | hydropower set of the access node | point array | which is input data |
| 18 | Power supply carbon intensity of the | Floating- | Power supply carbon intensity of each hydropower generator |
| | hydropower set of the access node | point array | set, which is input data |
| 19 | Input line set of the access node | Floating- | Active power of each input line, which is input data |
| | | point array | |
| 20 | Output line set of the access node | Floating- | Output power of each output line, which is input data |
| | | point array | |
| 21 | Load line set of the access node | Floating- | Output power of each input line, which is input data |
| | | point array | |
| 22 | Total power generation amount of the | Floating | Total power generation amount of the node, which is |
| | node | point | calculated data |
| 23 | Total carbon emission of the node | Floating | Total carbon emission from power generation by the node, |
| | | point | which is calculated data |
| 24 | Node carbon intensity | Floating | Node carbon intensity, which is calculated data |
| | | point | |

In step 703, the node carbon intensity is calculated based on a general carbon balance equation.

As shown in FIG. 9, this process includes the following steps:

In step 901, a power amount balance equation of the power node is constructed.

In step 902, a carbon balance equation of the power node is constructed.

In step 903, a node carbon matrix equation of the power system is constructed.

In step 904, the node carbon intensity of each of the power nodes is calculated based on the node carbon matrix equation.

For details, reference may be made to the above embodiment, where are not described herein any further.

In step 704, the node carbon intensity is displayed on the topological graph of the power nodes.

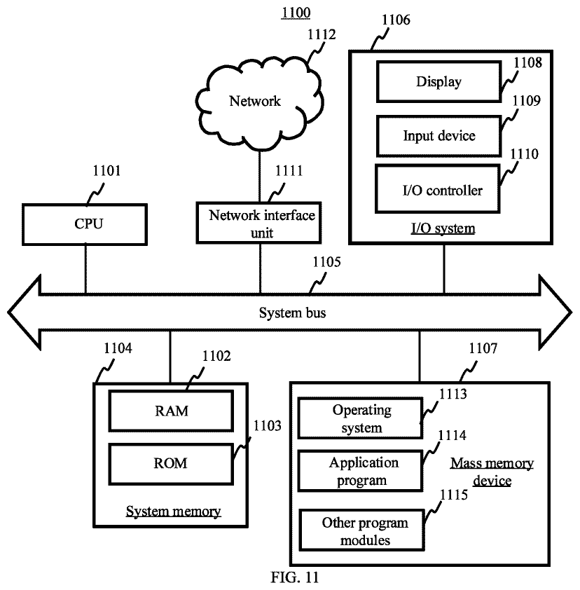

FIG. 10 is a structural block diagram of an apparatus for displaying carbon intensities according to an exemplary embodiment of the present disclosure. As shown in the figure, the apparatus includes: a data acquiring module 1001, a carbon intensity determining module 1002, and a carbon intensity display module 1003.

The data acquiring module 1001 is configured to acquire power flow data of power nodes in a power system, wherein the power nodes include a power station node, a transmission station node, and a load station node.

The carbon intensity determining module 1002 is configured to acquire a node carbon intensity of each of the power nodes is acquired by processing the power flow data based on a carbon balance relationship, wherein the node carbon intensity is a carbon emission on a power generation side when the power node generates, transmits or consumes a unit amount of power, and the carbon balance relationship indicates a balance between a total carbon emission corresponding to a power consumption of the power system and a total carbon emission from power generation by the power system.

The carbon intensity display module 1003 is configured to display the node carbon intensity of each of the power nodes on a topological graph of the power nodes, wherein the topological graph of the power nodes indicates a connection relationship between the power nodes, and different node carbon intensities are displayed in different display patterns.

In some embodiments, the carbon intensity determining module 1002 is further configured to:
calculate an input amount of power and an output amount of power of the power node based on the power flow data, wherein the input amount of power includes at least one of an amount of power of an input line and a power generation amount of a node generator set of the power node, and the output amount of power includes at least one of an amount of power of an output line and a load power consumption of the power node;
determine the power consumption of the power system based on an output amount of power and an input amount of power of each of the power nodes; and
determine the node carbon intensity of each of the power nodes based on the power consumption and a power generation carbon emission of a node generator set of each of the power nodes, wherein the power generation carbon emission of the node generator set is determined based on power supply carbon intensity and the power generation amount of the node generator set.

In some embodiments, the carbon intensity determining module 1002 is further configured to:
construct a power matrix based on a balance principle of the output amount of power and the input amount of power of each of the power nodes, wherein a matrix dimension of the power matrix is the same as a quantity of the power nodes, and the power matrix indicates input and output amounts of power or power consumptions of the power nodes;
construct a power carbon emission vector based on a power generation carbon emission of each node generator set; and
determine a carbon intensity matrix based on the power matrix and the power carbon emission vector, wherein the carbon intensity matrix indicates the node carbon intensity of each of the power nodes.

In some embodiments, the carbon intensity determining module 1002 is further configured to:
calculate the power generation amount of the node generator set and the amount of power of the output line based on power flow data of the power station node;
calculate the amount of power of the input line and the amount of power of the output line based on power flow data of the transmission station node; and
calculate the amount of power of the input line and the load power consumption based on power flow data of the load station node.

In some embodiments, the node carbon intensity is displayed in a node color.

In some embodiments, the carbon intensity display module 1003 is further configured to:
determine a node color of the power node and a line color of a node connection line based on a magnitude of the node carbon intensity, wherein the node connection line represents a transmission line between the power nodes, the line color indicates line carbon intensity, and the line carbon intensity is the same as a node carbon intensity of an output-end node of the transmission line; and
display each of the power nodes and each node connection line on the topological graph of the power nodes in the node color and the line color.

In some embodiments, the apparatus further includes: a carbon determining module, configured to determine a carbon emission or a carbon flow of each of the power nodes and a carbon flow of a transmission line between the power nodes based on the node carbon intensity of each of the power nodes; and a carbon displaying module, configured to display the carbon emission or the carbon flow of each of the power nodes and the carbon flow of the transmission line on the topological graph of the power nodes.

In some embodiments, the carbon determining module is further configured to:
determine a product of a total power generation amount of a node generator set of the power station node and a node carbon intensity of the power station node as a power generation carbon emission of the power station node;
determine a product of an amount of power of an input line of the transmission station node and a node carbon intensity of the transmission station node as a carbon flow of the transmission station node;
determine a product of a load power consumption of the load station node and a node carbon intensity of the load station node as a power consumption carbon emission of the load station node; and
determine a product of a transmitted amount of power of the transmission line and a node carbon intensity of an output-end node of the transmission line as a carbon flow of the transmission station node.

In some embodiments, the carbon display module is further configured to:
determine a node size of the power node based on the carbon emission or the carbon flow of the power node, wherein the carbon emission or the carbon flow is positively correlated with the node size;
determine a line thickness of a node connection line based on the carbon flow of the transmission line, wherein the node connection line represents the transmission line;
determine a direction of a flow arrow between node connection lines based on a carbon flow direction of the transmission line, wherein the direction of the flow arrow represents a carbon flow direction between the power nodes; and
display each of the power nodes, the node connection line, and the direction of the flow arrow between the node connection lines on the topological graph of the power nodes based on the node size and the line thickness.

In some embodiments, the data acquiring module 1001 is further configured to acquire power flow data of the power nodes in the power system within target time; and the carbon intensity determining module 1002 is further configured to acquire the node carbon intensity of each of the power nodes within the target time by processing the power flow data within the target time based on the carbon balance relationship.

In conclusion, in this embodiment of the present disclosure, the node carbon intensity of each of the power nodes in the power system is calculated based on the power flow data of the power nodes in the power system and the total carbon emission from power generation by the power system, such that the node carbon intensities corresponding to the power station node, the transmission station node, and the load station node in the power system are acquired and displayed in the topological graph of the power nodes. In this way, the corresponding carbon intensity of each node in the power system is accurately monitored, and a particle size of carbon intensity analysis is increased. In addition, the carbon intensity of each of the power nodes is displayed on the topological graph of the power nodes, such that distribution of carbon flow trajectories is visually displayed, and hence carbon emissions are tracked and traced.

FIG. 11 is a schematic structural diagram of a computer device according to an exemplary embodiment of the present disclosure. Specifically, the computer device 1100 includes a central processing unit (CPU) 1101, a system memory 1104 including a random-access memory (RAM) 1102 and a read-only memory (ROM) 1103, and a system bus 1105 connected between the system memory 1104 and the CPU 1101. The computer device 1100 further includes a basic input/output system (I/O system) 1106 that helps information transmission between various devices in a computer, and a mass memory device 1107 for storing an operating system 1113, an application program 1114, and other program modules 1115.

The basic I/O system 1106 includes a display 1108 for displaying information and an input device 1109 such as a mouse and a keyboard for a user to input information. Both the display 1108 and the input device 1109 are connected to the CPU 1101 through an I/O controller 1110 connected to the system bus 1105. The basic I/O system 1106 may further include the I/O controller 1110 for receiving and processing inputs from a plurality of other devices such as the keyboard, the mouse, and an electronic stylus. Similarly, the I/O controller 1110 further provides an output to a display screen, a printer, or another type of output device.

The mass memory device 1107 is connected to the CPU 1101 through a mass memory controller (not shown) connected to the system bus 1105. The mass memory device 1107 and its associated computer-readable medium provide a nonvolatile memory for the computer device 1100. In other words, the mass memory device 1107 may include the computer-readable medium (not shown) such as a hard disk or a drive.

Without loss of generality, the computer-readable medium may include a computer storage medium and a communication medium. The computer storage medium includes volatile and nonvolatile, and removable and non-removable media implemented in any method or technique for storing information such as computer-readable instructions, data structures, program modules, or other data. The computer storage medium includes a RAM, a ROM, a flash memory or another solid-state memory device, a compact disc read only memory (CD-ROM), a digital versatile disc (DVD) or another optical memory, a magnetic tape cartridge, a magnetic tape, a disk memory, or another magnetic memory device. Certainly, those skilled in the art know that the computer storage medium is not limited to the above. The system memory 1104 and mass memory device 1107 may be collectively referred to as a memory.

The memory stores one or more programs, wherein the one or more programs are configured to be executed by one or more CPUs 1101, and the one or more programs contain instructions for implementing the above methods. The CPU 1101 executes the one or more programs to implement the methods provided in the above method embodiments.

According to the embodiments of the present disclosure, the computer device 1100 may further be connected to a remote computer on a network through a network such as the Internet. That is, the computer device 1100 may be connected to the network 1112 through a network interface unit 1111 connected to the system bus 1105, or may be connected to another type of network or remote computer system (not shown) by the network interface unit 1111.

The memory further includes one or more programs. The one or more programs are stored in the memory and contain steps performed by the computer device in the method provided in the embodiments of the present disclosure.

An embodiment of the present disclosure further provides a computer-readable storage medium. The computer-readable storage medium stores at least one instruction, at least one program segment, a code set, or an instruction set. The at least one instruction, the at least one program segment, the code set, or the instruction set, when loaded and executed by a processor of a computer device, causes the computer device to perform the method for displaying carbon intensities according to any one of the above embodiments.

An embodiment of the present disclosure further provides a computer program product or a computer program, wherein the computer program product or the computer program includes at least one computer instruction stored in a computer-readable storage medium. The at least one computer instruction, when loaded and executed by a processor of a computer device, causes the computer device to perform the method for displaying carbon intensities according to any one of the above embodiments.

Those of ordinary skill in the art can understand that all or some of the steps in the methods of the above embodiments may be implemented by a program instructing related hardware. The program may be stored in a computer-readable storage medium. The computer-readable storage medium may be contained in the memory described in the above embodiments, or may exist alone without being assembled in a terminal. The computer-readable storage medium stores at least one instruction, at least one program segment, a code set, or an instruction set, and the at least one instruction, the at least one program segment, the code set, or the instruction set is loaded and executed by a processor to implement the method for displaying carbon intensities described in the method for displaying carbon intensities described in any one of the above embodiments.

Optionally, the computer-readable storage medium may include a ROM, a RAM, a solid-state drive (SSD), an optical disk, or the like. The RAM may include a resistance random-access memory (ReRAM) and a dynamic random-access memory (DRAM). The serial numbers of the embodiments of the present disclosure are merely for description and do not represent a preference of the embodiments.

Those of ordinary skill in the art can understand that all or some of the steps in the foregoing embodiments may be implemented by hardware, or by instructing related hardware by using a program. The program may be stored in a computer-readable storage medium. The storage medium may be a read-only memory, a disk, a compact disc, or the like.

Described above are merely exemplary embodiments of the present disclosure and are not intended to limit the present disclosure. Any modification, equivalent replacement, and improvement within the spirit and principle of the present disclosure shall be included within the protection scope of the present disclosure.

What is claimed is:

1. A method for displaying carbon intensities, comprising:
acquiring power flow data of power nodes in a power system, wherein the power nodes comprise a power station node, a transmission station node, and a load station node;
acquiring a node carbon intensity of each of the power nodes by processing the power flow data based on a carbon balance relationship, wherein the node carbon intensity indicates a carbon emission on a power generation side when the power node generates, transmits or consumes a unit amount of power, and the carbon balance relationship indicates a balance between a total carbon emission corresponding to power consumption of the power system and a total carbon emission from power generation by the power system; and
displaying the node carbon intensity of each of the power nodes on a topological graph of the power nodes, wherein the topological graph of the power nodes indicates a connection relationship between the power nodes, and different node carbon intensities are displayed in different display patterns.

2. The method according to claim 1, wherein acquiring the node carbon intensity of each of the power nodes by processing the power flow data based on the carbon balance relationship comprises:
calculating an input amount of power and an output amount of power of the power node based on the power flow data, wherein the input amount of power comprises at least one of an amount of power of an input line and a power generation amount of a node generator set of the power node, and the output amount of power comprises at least one of an amount of power of an output line and a load power consumption of the power node;
determining the power consumption of the power system based on the output amount of power and the input amount of power of each of the power nodes; and
determining the node carbon intensity of each of the power nodes based on the power consumption and a power generation carbon emission of the node generator set of each of the power nodes, wherein the power generation carbon emission of the node generator set is determined based on power supply carbon intensity and the power generation amount of the node generator set.

3. The method according to claim 2, wherein
determining the power consumption of the power system based on the output amount of power and the input amount of power of each of the power nodes comprises:
constructing a power matrix based on a principle of balance between the output amount of power and the input amount of power of each of the power nodes, wherein a matrix dimension of the power matrix is the same as a quantity of the power nodes, and the power matrix indicates input and output amounts of power or power consumptions of the power nodes; and
determining the node carbon intensity of each of the power nodes based on the power consumption and the power generation specific carbon emission of the node generator set of each of the power nodes comprises:
constructing a power carbon emission vector based on a power generation carbon emission of each node generator set; and
determining a carbon intensity matrix based on the power matrix and the power carbon emission vector, wherein the carbon intensity matrix indicates the node carbon intensity of each of the power nodes.

4. The method according to claim 2, wherein calculating the input amount of power and the output amount of power of the power node based on the power flow data comprises:
calculating the power generation amount of the node generator set and the amount of power of the output line based on the power flow data of the power station node;
calculating the amount of power of the input line and the amount of power of the output line based on the power flow data of the transmission station node; and
calculating the amount of power of the input line and the load power consumption based on the power flow data of the load station node.

5. The method according to claim 1, wherein the node carbon intensity is displayed in a node color; and
displaying the node carbon intensity of each of the power nodes on the topological graph of the power nodes comprises:
determining a node color of the power node and a line color of a node connection line based on a magnitude of the node carbon intensity, wherein the node connection line represents a transmission line between the power nodes, the line color indicates a line carbon intensity, and the line carbon intensity is the same as a node carbon intensity of an output-end node of the transmission line; and
displaying each of the power nodes and each node connection line on the topological graph of the power nodes in the node color and the line color.

6. The method according to claim 1, wherein upon acquiring the node carbon intensity of each of the power nodes by processing the power flow data and the power supply carbon intensity based on the carbon balance relationship, the method further comprises:
determining a carbon emission or a carbon flow of each of the power nodes and a carbon flow of a transmission line between the power nodes based on the node carbon intensity of each of the power nodes; and
displaying the carbon emission or the carbon flow of each of the power nodes and the carbon flow of the transmission line on the topological graph of the power nodes.

7. The method according to claim 6, wherein determining the carbon emission or the carbon flow of each of the power nodes and the carbon flow of the transmission line between the power nodes based on the node carbon intensity of each of the power nodes comprises:
determining a product of a total power generation amount of a node generator set of the power station node and a node carbon intensity of the power station node as a power generation carbon emission of the power station node;
determining a product of an amount of power of an input line of the transmission station node and a node carbon intensity of the transmission station node as a carbon flow of the transmission station node;
determining a product of a load power consumption of the load station node and a node carbon intensity of the load station node as a power consumption carbon emission of the load station node; and
determining a product of a transmitted amount of power of the transmission line and a node carbon intensity of an output-end node of the transmission line as a carbon flow of the transmission station node.

8. The method according to claim 6, wherein displaying the carbon emission or the carbon flow of each of the power nodes and the carbon flow of the transmission line on the topological graph of the power nodes comprises:
determining a node size of the power node based on the carbon emission or the carbon flow of the power node, wherein the carbon emission or the carbon flow is positively correlated with the node size;
determining a line thickness of a node connection line based on the carbon flow of the transmission line, wherein the node connection line represents the transmission line;
determining a direction of a flow arrow between the node connection lines based on a carbon flow direction of the transmission line, wherein the direction of the flow arrow represents a carbon flow direction between the power nodes; and
displaying each of the power nodes, the node connection line, and the direction of the flow arrow between the node connection lines on the topological graph of the power nodes based on the node size and the line thickness.

9. The method according to claim 1, wherein
acquiring the power flow data of the power nodes in the power system comprises:
acquiring the power flow data of the power nodes in the power system within target time; and
acquiring the node carbon intensity of each of the power nodes by processing the power flow data based on the carbon balance relationship comprises:
acquiring the node carbon intensity of each of the power nodes within the target time by processing the power flow data within the target time based on the carbon balance relationship.

10. An apparatus for displaying carbon intensities, comprising:
a data acquiring module, configured to acquire power flow data of power nodes in a power system, wherein the power nodes comprise a power station node, a transmission station node, and a load station node;
a carbon intensity determining module, configured to acquire a node carbon intensity of each of the power nodes by processing the power flow data based on a carbon balance relationship, wherein the node carbon intensity is a carbon emission on a power generation side when the power node generates, transmits or consumes a unit amount of power, and the carbon balance relationship indicates a balance between a total carbon emission corresponding to a power consumption of the power system and a total carbon emission from power generation by the power system; and
a carbon intensity displaying module, configured to display the node carbon intensity of each of the power nodes on a topological graph of the power nodes, wherein the topological graph of the power nodes indicates a connection relationship between the power nodes, and different node carbon intensities are displayed in different display patterns.

11. A computer device, comprising: a processor and a memory storing at least one program therein, wherein the at least one program, when loaded and run by the processor, causes the computer device to perform the method for displaying carbon intensities as defined in claim 1.

12. A computer-readable storage medium storing at least one program therein, wherein the at least one program, when loaded and run by a processor of a computer device, causes the computer device to perform the method for displaying carbon intensities as defined in claim 1.

13. A computer program product, comprising: at least one computer instruction stored in a computer-readable storage medium, wherein the at least one computer instruction, when loaded and executed by a processor of a computer device, causes the computer device to perform the method for displaying carbon intensities as defined in claim 1.
